(19) United States
(12) Patent Application Publication
(10) Pub. No.: US 2008/0141157 A1
(43) Pub. Date: Jun. 12, 2008

(54) Over-air content shuffling for mobile electronic device

(76) Inventor: Richard Eric Helvick, Portland, OR (US)

Correspondence Address: SHARP LABORATORIES OF AMERICA, INC., 1320 PEARL ST., SUITE 228, BOULDER, CO, 80302, US

(21) Appl. No.: 11/634,678

(22) Filed: Dec. 6, 2006

(51) Int. Cl. G06F 15/16; G06F 3/048

(52) U.S. Cl. 715/771; 709/217

(57) ABSTRACT

Content shuffling for a mobile electronic device invokes the device's wireless interface to automatically refresh content stored on the device based on the content's history. Such a mobile electronic device in some embodiments comprises a wireless interface, a memory having refreshable content stored thereon and a processor communicatively coupled with the wireless interface and the memory, wherein under control of the processor the device maintains historical information on the refreshable content and automatically replaces with replacement content received via the wireless interface a subset of the refreshable content selected based on the historical information.

### BACKGROUND OF THE INVENTION

The present invention relates to receipt of over-the-air content on mobile electronic devices, and more particularly to shuffling of over-the-air content stored on a mobile electronic device.

Mobile electronic devices, such as cellular phones, MP3 players and pocket PCs, can provide entertainment to their users by rendering various types of content, such as music, video clips and video games, from electronic files. Storage limitations on mobile electronic devices, however, often prevent contemporaneous storage on the device of all of the content files for which a user is licensed. If a user wishes to refresh the content on the device, the user must typically plug the device into a personal computer and run software to replace old content files with new content files. While serviceable, this traditional approach to content swapping requires access to a personal computer, imposes on the user the burden to learn how to interface with the personal computer and use content swapping software and takes the user's time.

### SUMMARY OF THE INVENTION

The present invention, in a basic feature, provides a content shuffling capability for a mobile electronic device that invokes the wireless interface of the device to automatically refresh content stored on the device based on the history of the content.

In one aspect of the invention, a mobile electronic device comprises a wireless interface, a memory having refreshable content stored thereon and a processor communicatively coupled with the wireless interface and the memory, wherein under control of the processor the device maintains historical information on the refreshable content and automatically replaces with replacement content received via the wireless interface a subset of the refreshable content selected based on the historical information. The historical information may include one or more of a download history and a play history of the refreshable content. Automatic replacement may be performed periodically. The replacement content may be selected randomly. The memory may further have non-refreshable content stored thereon. Content received on the device through means other than automatic replacement may be designated non-refreshable. The user may specify an amount of space within the memory for storing refreshable content.

In another aspect of the invention, a mobile electronic device comprises a wireless interface, a memory having refreshable content stored thereon and a processor communicatively coupled with the wireless interface and the memory, wherein under control of the processor and without user intervention the device periodically replaces with replacement content received via the wireless interface at least a subset of the refreshable content.

In another aspect of the invention, a method for shuffling content on a mobile electronic device comprises the steps of receiving refreshable content via a wireless interface, maintaining historical information on the refreshable content, selecting a subset of the refreshable content for replacement based on the historical information, receiving replacement content via the wireless interface and replacing the subset of refreshable content with the replacement content.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 is a system diagram of a network in accordance with an embodiment of the invention.

FIG. 2 is a block diagram of a mobile electronic device in accordance with an embodiment of the invention.

FIG. 3 is a block diagram showing elements within a mobile electronics device main memory in accordance with an embodiment of the invention.

FIG. 4 is a flow diagram showing operation of a mobile electronic device in accordance with an embodiment of the invention.

### DESCRIPTION OF A PREFERRED EMBODIMENT

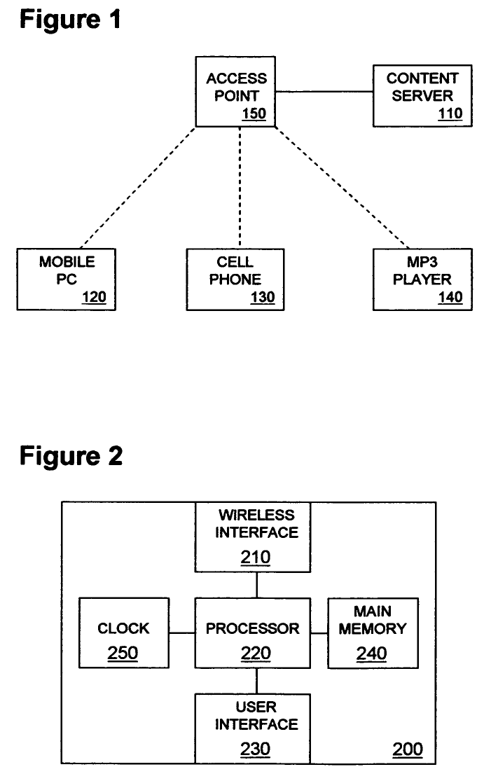

In FIG. 1, a network in accordance with one embodiment of the invention is shown. The network includes a content server 110 in a network infrastructure. Server 110 may reside in an enterprise network or a service provider network, for example. Server 110 has wired connectivity with an access point 150, such as a cellular base station or a wireless LAN access point. The connectivity may be direct or via one or more intervening data communication nodes such as routers, switches and bridges. Access point 150 has wireless connectivity with a plurality of mobile electronic devices 120, 130, 140 via respective over-air links. Over-air links may include various types of wireless links over which data may be transmitted, such as a cellular links or wireless LAN links. Mobile electronic devices 120, 130, 140 shown include a mobile PC 120, a cellular phone 130 and an MP3 player 140, although other types of electronic devices having a wireless interface, such as mobile gaming consoles, may be deployed. In other embodiments, the mobile electronic devices in the network may be homogenous, that is, all may fit within the same product class (e.g. cell phones).

In a basic feature, content server 110 stores and distributes content to mobile electronic devices, such as devices 120, 130, 140. Devices 120, 130, 140 may be or may belong to, for example, subscribers to a content distribution service facilitated by server 110. Content stored and distributed by server 110 may include, for example, electronic music files, electronic video clip files and electronic video game files. In the described embodiments content is pulled from server 110 pursuant to requests made by devices 120, 130, 140. In other embodiments, however, content may pushed by a content server to mobile electronic devices independent of any device request.

Turning to FIG. 2, a representative mobile electronic device 200 in accordance with an embodiment of the invention is shown. Device 200 includes a wireless interface 210 adapted to transmit and receive data in accordance with a wireless communication protocol, such as a cellular or wireless LAN protocol. Device 200 further includes a user interface 230 adapted to transmit outputs and receive inputs from a user of device 200. User interface 230 may, for example, include a display and a mechanism for user input such as a keypad or a touch-sensitive navigation tool. Device 200 further includes a main memory 240 adapted to store device software, content files and associated data. Device 200 further includes a clock 250 adapted to keep current time. Clock 250 may be initialized by the network. Alternatively, device 200 may have a GPS receiver and clock 250 may be initialized thereby. Device 200 further includes a processor 220 adapted to execute device software stored in main memory 240 and manage elements 210, 230, 240, 250 and interactions to perform the various features and functions supported by device 200.

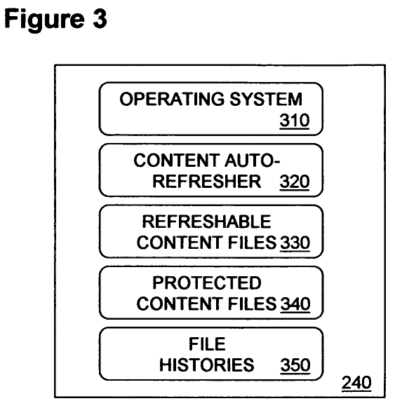

Turning now to FIG. 3, main memory 240 is shown in more detail to include certain device software, content files and associated data, including an operating system 310, a content auto-refresher 320, refreshable content files 330, protected content files 340 and file histories 350. Refreshable files 330 are electronic files received from server 110 over wireless interface 210 that are subject to replacement by auto-refresher 320. Protected files 340 are electronic files that are not subject to replacement by auto-refresher 320. In some embodiments, content files downloaded from server 110 pursuant to requests made by a user of device 200 are designated as protected files 340, whereas content files received from server 110 independent of any user request are designated as refreshable files 330. In some embodiments, a user of device 200 may change the designation of content files through inputs on user interface 230. In some embodiments, a user of device 200 specifies through inputs on user interface 230 an amount of space within main memory 240 that may be used for storing refreshable files 330.

Auto-refresher 320 is a software program adapted to track the history of refreshable files 330 and selectively replace refreshable files 330 at defined intervals without user intervention. Auto-refresher 320, running on processor 220 and interoperating with clock 250, creates and updates file histories 350 for refreshable files 330 by logging events involving refreshable files 330. Logged events include arrival times and ploy times of refreshable files 330. Auto-refresher 320 periodically selects a subset of refreshable files 330 for replacement based on information from file histories 350 and replaces the selected subset with replacement files received from server 110. The subset of refreshable files 330 selected for replacement during each refresh cycle may include a fixed percentage of files 330, for example, 50%. Alternatively, the percentage of refreshable files 330 selected for replacement may vary across refresh cycles. The refresh period may be daily, weekly, every two weeks, or another defined time period. In some embodiments, a user of device 200 specifies a “per cycle” replacement percentage and a refresh period through inputs on user interface 230.

To replace the subset of refreshable files 330, auto-refresher 320 periodically issues requests for replacement files to server 110 which prompts download of replacement files to device 200 via wireless interface 210. Auto-refresher 320 stores replacement files downloaded from server 100 in locations of main memory 240 formerly occupied by the subset of refreshable files 330 selected for replacement. In some embodiments, auto-refresher 320 issues a single request in each refresh cycle that specifies an aggregate size requirement for replacement files and is followed by a bulk download of replacement files which in aggregate meet the required size. In other embodiments, auto-refresher 320 issues a first request followed by download of a first replacement file, then issues a second request followed by download of a second replacement file, and so on, until the aggregate size requirement for replacement files is met. In some embodiments, replacement files are randomly selected by server 110 from among all content files for which device 200 or a user thereof is licensed. In other embodiments, to prevent redundancy, a request identifies refreshable content files 330 currently stored on device 200 and the replacement files are selected by server 110 from among a subset of licensed content files that are not identified in the request. In still other embodiments, replacement files are selected by server 110 based on a content correlation with content files previously downloaded from server 110 pursuant to requests made by a user of device 200 or a popularity metric based on requests made by users of the content distribution service. To facilitate a content correlation, auto-refresher 320 may include in requests identities of refreshable content files 330 that are not being replaced or protected media files 340. In this way, device 200 provides a hint to server 110 about the type of content preferred by a user of device 200.

Auto-refresher 320 may employ any number of selection algorithms in conjunction with information in file histories 350 to select refreshable files 330 for replacement. One algorithm selects refreshable files 330 that have been stored on device 200 the longest. Another algorithm selects files 330 that have been least recently played. Another algorithm selects files 330 that have been least frequently played. Yet another algorithm selects files 330 that have been most frequently played. Still other algorithms apply multiple factors (e.g. download history, play history) hierarchically. For example, such an algorithm may select files 330 that have been least frequently played and in the event of a tie select files 330 that have been stored on device 200 the longest and in the event of a tie select files 330 that have been least recently played. Other multi-factor algorithms may assign weights to different factors, calculate scores for files 330 based on the weighted factors and select files 330 based on the calculated scores. In some embodiments, a user of device 200 may specify a selection algorithm through inputs on user interface 230.

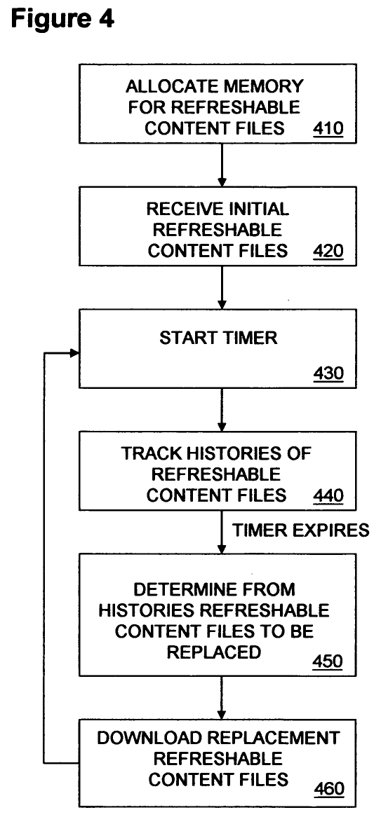

Referring to FIG. 4, a flow diagram shows operation of device 200 in accordance with an embodiment of the invention. A user allocates an amount of space within memory 240 for refreshable files 330 (410). Memory allocation may be accomplished through inputs on user interface 230 and may be expressed in terms of data size or a percentage, for example. An initial set of refreshable files 330 is then received from content server 110 (420). Receipt of the initial set of refreshable files 330 may be accomplished through issuance by auto-refresher 320 to server 110 via wireless interface 210 of a request and download from server 110 to device 200 via wireless interface 210 of refreshable files 330 in response to the request. The initial refreshable files 330 are stored in memory 240 and auto-refresher 320 creates a log in file histories 350 for each of the refreshable files 330 including the time of receipt or storage as an initial log entry. Auto-refresher 320 then starts a timer (430) that is set to expire at the end of the interval between refreshes, which is defined by the refresh period. The refresh period may be specified by the user through inputs on user interface 230.

During the interval between refreshes, auto-refresher 320 continually monitors and updates the histories of refreshable files 330 (440). Whenever one of refreshable files 330 is played, auto-refresher 320 adds a log entry in the one of file histories 350 that is associated with the played file. The log entry includes the time that the file was played. When the timer expires at the end of the interval between refreshes, auto-refresher 320 consults file histories 350 and determines algorithmically based on the log entries a subset of refreshable files 330 to be replaced (450). A set of replacement files is then received from server 110 (460). Receipt of the replacement files may be accomplished through issuance by auto-refresher 320 to server 110 via wireless interface 210 of a request and download from server 110 to device 200 via wireless interface 210 of replacement files in response to the request. Replacement files are stored in memory 240 in locations previously occupied by the subset of refreshable files 330 that were identified for replacement. Auto-refresher 320 creates logs in file histories 350 for each of the replacement files, which files are now part of refreshable files 330, including the time of receipt or storage as initial log entries. Auto-refresher 320 then restarts the timer (460) set to expire at the end of the next interval between refreshes.

It will be appreciated by those of ordinary skill in the art that the invention can be embodied in other specific forms without departing from the spirit or essential character hereof. For example, in some embodiments file histories may keep a play count for refreshable content files without tracking play times. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A mobile electronic device, comprising:
a wireless interface;
a memory having refreshable content stored thereon; and
a processor communicatively coupled with the wireless interface and the memory, wherein under control of the processor the device maintains historical information on the refreshable content and automatically replaces with replacement content received via the wireless interface a subset of the refreshable content selected based on the historical information.

2. The device of claim 1, wherein the historical information includes a download history of the refreshable content.

3. The device of claim 1, wherein the historical information includes a play history of the refreshable content.

4. The device of claim 1, wherein automatic replacement is performed periodically.

5. The device of claim 1, wherein the replacement content is selected randomly.

6. The device of claim 1, wherein the replacement content is selected based on a correlation of the replacement content with content stored in the memory.

7. The device of claim 1, wherein the replacement content is refreshable.

8. The device of claim 1, wherein the memory further has non-refreshable content stored thereon.

9. The device of claim 8, wherein the non-refreshable content is received on the device by means other than automatic replacement.

10. The device of claim 1, further comprising a user interface communicatively coupled with the processor wherein a user specifies through inputs on the user interface an amount of space within the memory for storing refreshable content.

11. The device of claim 1, further comprising a user interface communicatively coupled with the processor wherein a user specifies through inputs on the user interface a refresh period.

12. The device of claim 1, wherein the refreshable content includes music files.

13. The device of claim 1, wherein the device is a cell phone.

14. A method for shuffling content on a mobile electronic device, comprising the steps of:
receiving refreshable content via a wireless interface;
maintaining historical information on the refreshable content;
selecting a subset of the refreshable content for replacement based on the historical information;
receiving replacement content via the wireless interface; and
replacing the subset of refreshable content with the replacement content.

15. The method of claim 14, wherein the steps are performed independent of any user request.

16. The method of claim 14, wherein the historical information includes a download history of the refreshable content.

17. The method of claim 14, wherein the historical information includes at least one of a play history and a play count for the refreshable content.

18. A mobile electronic device, comprising:
a wireless interface;
a memory having refreshable content stored thereon; and
a processor communicatively coupled with the wireless interface and the memory, wherein under control of the processor and without user intervention the device periodically replaces with replacement content received via the wireless interface at least a subset of the refreshable content.

19. The device of claim 18, further comprising a user interface communicatively coupled with the processor wherein a user specifies through inputs on the user interface at least one of an amount of space on the memory for storing the refreshable content and a refresh period.

20. The device of claim 18 wherein the device is a mobile phone.
